(19) United States
(12) Patent Application Publication
(10) Pub. No.: US 2015/0356452 A1
(43) Pub. Date: Dec. 10, 2015

(54) DISTRIBUTED DYNAMIC DETECTION OF SIGNATURES FROM ENTITY INDICATORS

(71) Applicant: Axon Al, LLC, Harrisonburg, VA (US)

(72) Inventor: Sven A. Brueckner, Harrisonburg, VA (US)

(21) Appl. No.: 14/733,021

(22) Filed: Jun. 8, 2015

Related U.S. Application Data
(60) Provisional application No. 62/010,066, filed on Jun. 10, 2014.

(51) Int. Cl. G06N 7/00; G06N 5/02

(52) U.S. Cl. CPC G06N 7/005; G06N 5/02

(57) ABSTRACT

Autonomous computational processes (“agents”) representing application-specific domain entities are provided with application-independent methods and data structures to monitor one or more streams of behavioral indicator data observed in their respective entities and detect and report the presence of application-defined patterns of satisfied constraints (signatures) in real time. The invention specifies two agent populations, one (“Host Agents”) representing each domain entity with a dedicated agent that maintains current signature detection probabilities (and their constraint components), the other (“Indicator Agents”) continuously monitoring the behavioral indicator data and updating constraint satisfaction and signature detection probabilities.

### REFERENCE TO RELATED APPLICATION

This application claims priority from U.S. Provisional Patent Application Ser. No. 62/010,066, filed Jun. 10, 2014, the entire content of which is incorporated herein by reference.

### FIELD OF THE INVENTION

This invention relates generally to information processing and, in particular, to a method of detecting arbitrary signatures in sets of observable indicators in a dynamically changing set of observable domain entities of interest.

### BACKGROUND OF THE INVENTION

In many application domains, a key function is to monitor a collection of domain entities, to identify those that currently behave different than expected, and to classify this deviation from expected. For instance, in cyber security, an application may monitor the operation of a set of devices (e.g., mobile phones, routers, smart sensors, etc.), identify those that fall outside of their expected behavior pattern, and raise an alert if that deviation is indicative of a known cyber threat. Another example is the monitoring various vital signs of patients in a hospital, identify those patients that exhibit patterns deviating from those expected given their current condition, and alert the medical staff if this deviation can be classified as requiring intervention.

While there exist various forms of automated pattern classification technologies (generally in the field of Data Mining), the vast majority of these techniques require that the data that is to be analyzed (here the stream of behavior observations of the domain entities) is transmitted to a central processing center. The present invention removes this requirement by decentralizing the data processing and pushing it (as close as feasible in the specific application) to the source of the data. This alignment of the topology of the distributed and decentralized data processing with the topology of the application domain (e.g., all devices in the above cyber security example participate in the behavior deviation identification and classification), allows that application to scale linearly with the number of monitored domain entities and perform robustly even as the set of entities continuously changes.

### SUMMARY OF THE INVENTION

The general purpose of the present invention is to detect arbitrary signatures (e.g., abnormal behavior, high or low utilization) in sets of observable indicators (e.g., behavior measurements, activity reports) in a dynamically changing set of observable domain entities of interest (e.g., computing devices, humans). The invention describes a collection of computational processes, methods and data structures that are combined in a given application to a specific choice of domain entities, signatures of interest, and observable indicators (e.g., monitoring computer users for abnormal behavior that may indicate a threat). The key novelty of this invention is that the computational processes are decentralized and may be distributed to the domain entities, thereby removing the requirement for high-volume data transfer to an external data processing center.

The autonomous computational processes (“agents”) embodying this invention are data structures in computational processes executed by one or many processors on a single or a collection of hardware platforms, where each such data structure references a location in a metric space. Any memory maintained by the agents as part of this invention is presumed to be computer memory (e.g., Random Access Memory (RAM), processor cache, (temporary) files stored on internal or external hard disks, databases). The location of any real-world entity represented by any agent may but does not need to correspond to the physical arrangement of the hardware platforms that execute the agents' repeated decision process.

### BRIEF DESCRIPTION OF THE DRAWINGS

FIG. 1 depicts the real-world entities generating observable data points from multiple indicator types and our invention seeking to detect signature across multiple indicators;

FIG. 2 shows how in this invention each domain entity (“Host”) is associated with an autonomous software process (agent) that has a unique location in the chosen application topology;

FIG. 3 illustrates the embedding of Host Agent instances in a Metric Space where the ability of agents to interact with each other is constrained by a “Perception Range” parameter (measure of distance in the metric space);

FIG. 4 illustrates the embedding of Host Agent instances in a Graph Topology, where each Graph Node is the location of exactly one Host Agent and where the existence of Graph Edges to neighboring nodes (“peers”) constraints the ability of agents to interact; and

FIG. 5 shows the data structures held by a Host Agent and how its internal management process, as well as interactions with Indicator Agents affect them.

### DETAILED DESCRIPTION OF THE INVENTION

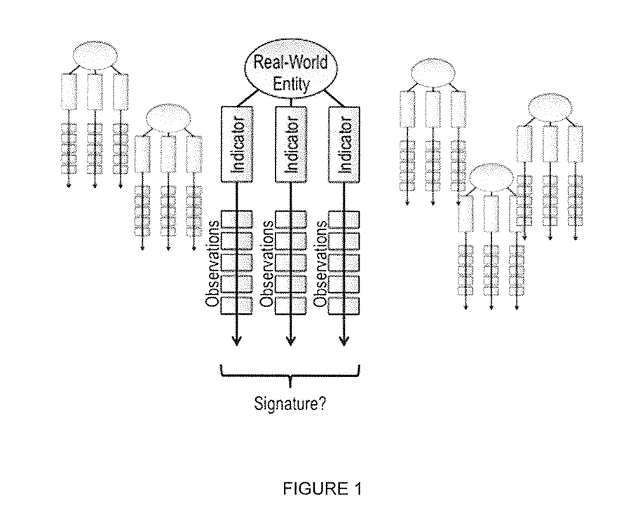

In the following, we present a system and method that, as illustrated in FIG. 1, detects arbitrary signatures (e.g., abnormal behavior, high or low utilization) in time series of reported values from sets of observable indicators (e.g., behavior measurements, activity reports) in a dynamically changing set of domain entities of interest (e.g., computing devices, humans). The specific entities of interest, what indicators are available, and how measurements from these indicators are combined into signatures of interest depends on the specific application (e.g., detecting the presence of malicious software on or more computing devices). We make the following set of assumptions:
1) Domain entities of interest (here we call them “Hosts”) may join or leave the application at any time.
2) Hosts are potentially spatially distributed, but as they join the system, we have the means to (intermittently) sample new measurements from some or all the indicators defined in the specific application.
3) Signatures of interest to the specific application are defined as a weighted set of constraints on measurements from the indicators. Each such constraint is defined over a subset of the available indicators. The satisfaction of each constraint adds the weight assigned to the constraint to the confidence that the signature is detected in the indicator measurements. Each confidence weight is a non-zero numerical value in (0,1] and the sum of the weights from all constraints in the signature is one.
4) The system may detect the presence of one or more signatures on any participating host.

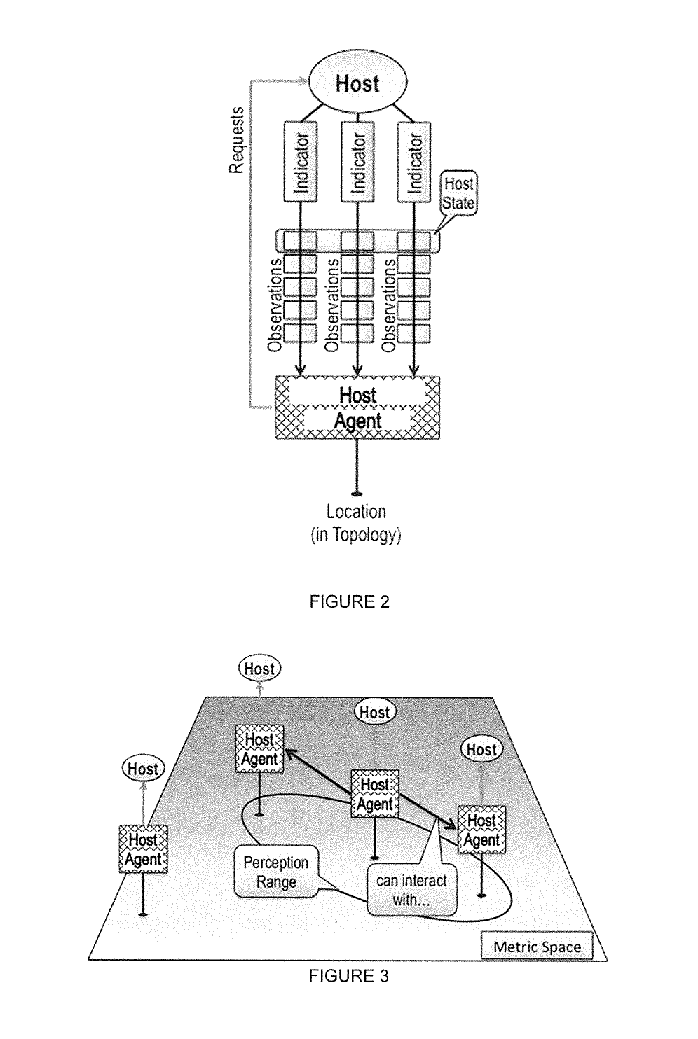

The present invention associates each domain entity with an autonomous software process (“agent”) for the duration of that entity's participation in the signature monitoring application. As we refer to the domain entities as Hosts, we refer to their associated agent as “Host Agent” (FIG. 2). The Host Agent acts as the representation of the Host in the application, providing other application components with access to current or past measurement values of behavioral indicators drawn from the Host and mediating requests for new measurements. We refer to sets of measurements across indicators as a “Host State” where the most recent measurements form the current Host State.

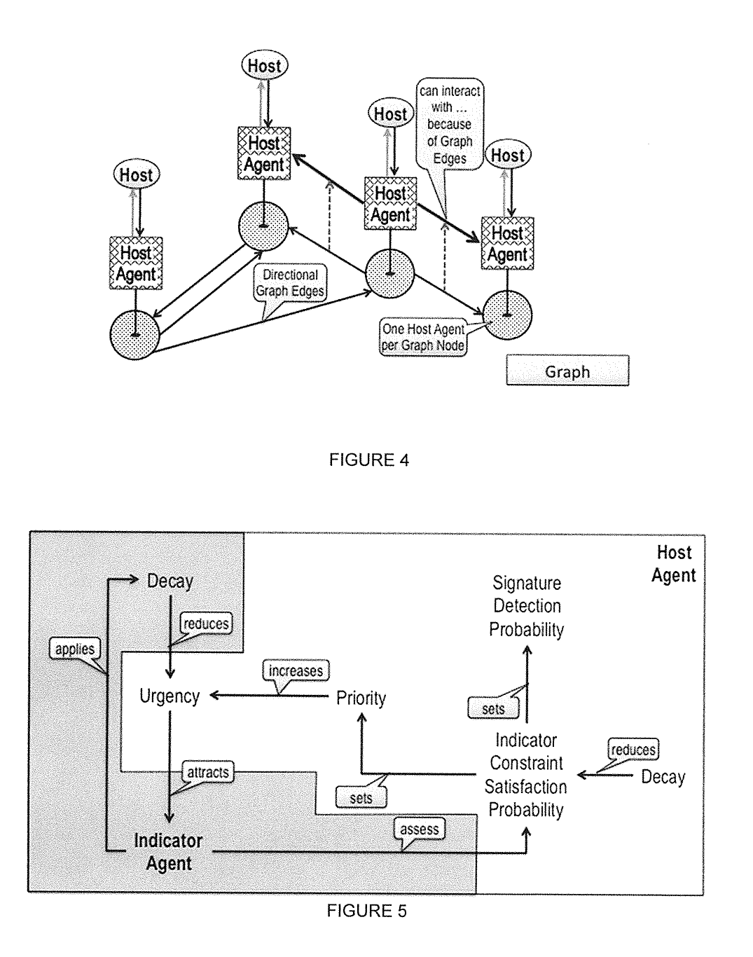

All Host Agents are embedded (have a unique location) in a computational topology that limits any agent's ability to interact with other agents to the subset of agents that are located “near” (by the distance measure defined in the specific topology) the agent. For instance, we may embed the agents in a metric space (as illustrated in FIG. 3) and limit their interaction to agents that are within an application-defined (parameter) distance. Or, we may define the topology as a directed graph (as illustrated in FIG. 4) with a unique node for each Host Agent and limit the interactions to those Host Agents that occupy the immediate neighbor nodes (“peers”). The choice of the topology in a specific application is influenced by the computations and communications infrastructure available to the application. For instance, if it is feasible to physically execute the Host Agent process in or on the Host entity and have them communicate with other Host's agents (such as in applications where the entities that are monitored are smart devices) then a graph topology may be the appropriate embedding.

The present invention prescribes two independently-executing, continuous processes for each Host Agent:
1) Knowledge Maintenance Process
2) Arrangement Process

### Host Agent Knowledge Maintenance Process

In support of the behavior signature analysis, each Host Agent maintains data structures in addition to the storage of current and past Host State instances. Specifically, there are two distinct data structures:
1) For each indicator that the specific Host entity supports, the Host Agent maintains an indicator priority value and a re-assessment urgency value.
2) Potentially for each signature the system is seeking to detect in the entity behavior, the Host Agent maintains an overall signature detection probability value, and then for each indicator constraint defined in the signature, a constraint satisfaction probability value.

In each cycle of its Knowledge Maintenance process, a Host Agent takes the following actions:
1) For each of its indicators, it adds the current priority value to the re-assessment urgency value.
2) For each of its currently held signatures, it first iterates over all the currently recorded signature's indicator constraint probability values and multiplies them with a fixed application-defined “decay” factor in the (0,1) interval—the result makes the new (reduced) constraint probability value—and then the Host Agent combines all the new constraint probability values of the signature (and their weight) into a new detection probability value of the signature. If individual constraint probability values drop below a fixed threshold, they are removed from this Host Agent's data structures. Likewise, if the detection probability value of a signature falls below a threshold, the entire signature data structure is removed.
3) For each of its indicators, the Host Agent re-computes the priority as the sum of a fixed base value and the indicator's constraint probability values across all signatures.

### Host Agent Arrangement Process

The present invention defines a continuously executing Host Agent arrangement process, where Host Agents move in the topology to be near other Host Agents with a similar current Host State and away from Host Agents whose current Host State is dissimilar. The specific measure of pair-wise similarity between Host State instances is defined by the application and the present invention only requires that one such measure exists.

The distance measure that defines whether two Host Agents are near each other or not is specific to the chosen topology. If a metric space embedding was chosen as illustrated in FIG. 3, then it would be natural to define Host Agent distance as the Euclidean distance in that space. In a graph embedding, agent distance may be defined, for instance, by the shortest path length between the nodes occupied by the respective agents.

Likewise, the means by which the Host Agents move in the topology to change their distance to other Host Agents depend on the choice of topology. A Host Agent's location in a metric space (as in FIG. 3) may be a coordinate vector in that space and movement takes the form of adding movement step vectors to the current agent location vector. In a graph topology embedding (as in FIG. 4), agents change their distance to other agents by adding or removing graph links. For example, if a Host Agent A wants to be closer to another Host Agent B who is currently only a peer of one of the peers of A, then A could establish a direct peer link to B and thereby reducing the shortest path length between A and B from 2 to 1 steps.

By continuously re-evaluating the similarity relationship to those Host Agents that are nearby in the chosen topology and then adjusting one's location in the topology to decrease distance to agents with similar current Host State and increase distance to dissimilar ones, each Host Agent contributes to a self-organizing clustering process that continuously adjusts to changing Host States and arriving or departing Host Agents. [1] presents a particular realization (using the surface of a torus as the embedding topology) of such a self-organizing clustering process in the context of information matching and retrieval.

With the Host Agents arranging themselves in the shared topology by similarity of their current Host State while maintaining a (limited) history of their Host State, any region is the topology that is occupied by Host Agent instances contains time series of indicator measurement values for multiple similar Hosts. Thereby we increase the density of data points that are available to the ongoing behavior analysis.

The self-organizing clustering process among Host Agents is fully decentralized and its execution may be distributed over multiple computational devices including, if they are capable of executing software processes and communicate, the Host entities themselves. This decentralization and distribution allows this process to scale linearly with the number of Host Agent instances to operate on vast numbers of Hosts.

### Behavior Analysis

The present invention prescribes a second agent population (in addition to the Host Agents) that we refer to as “Indicator Agents”. Those agents are not associated with any domain entity. Instead, their role is to perform the continuous analysis of the Hosts' behavior reflected in the time series of indicator measurement values in the respective Host State data structures.

Just as Host Agents, Indicator Agents are embedded in the chosen topology and are limited in their ability to interact with other agents to their current topological neighborhood. Specifically, as they move through the topology and thus move among the Host Agents, the Indicator Agents may choose to interact with a Host Agent. The cumulative effect of these Indicator-Host agent interactions is the detection and classification of signatures in the domain entity's behavior.

For each signature (set of weighted constraints over behavioral indicators), we deploy a population of (one or more) Indicator Agents into the embedding topology and thus the underlying computational infrastructure. Within each population each Indicator Agent knows what signature it belongs to (unique signature ID). We further divide the population of a single signature into groups of (one or more) Indicator Agents, each capable to assess only one specific constraint for one indicator in the signature—hence the name Indicator Agent.

Each Indicator Agent executes a continuous movement decision process and it may perform an interaction with a Host Agent. In the following, we discuss both activities.

### Indicator Agent Movement Decision

The purpose of the Indicator Agent's movement through the embedding topology is to find Host Agents that require an assessment of the Indicator Agent's specific signature constraint, either because the constraint had not been assessed in a while or the probability that the Indicator Agent's signature is present at that Host is high. Both factors are expressed in a Host Agent's re-assessment urgency value that it maintains (see section “Host Agent Knowledge Maintenance Process”) for each of its indicators. That urgency builds up over time as the indicator's priority is repeatedly added to the urgency value. And the priority value is high (letting urgency rise faster) if signature constraints on that indicator have a high probability of currently being met.

From the perspective of a particular Indicator Agent “A”, with a set of Host Agents “H={h₁, . . . , hₙ}” currently close enough to be in perception range, A biases its movement choice by the current re-assessment urgency values of each hᵢ for the indicator that A represents. Thus the set “U={u₁, . . . , uₙ}” denotes those urgency values for all elements of H. The likelihood that A moves towards a given Host Agent's hᵢ current location is proportional to uᵢ.

The construction of a movement step in the embedding topology and biased by U depends on the nature of the topology. In the example case where the embedding environment is a metric space (FIG. 3), A may compute its next movement step as the (length-constrained) sum of vectors directed towards each hᵢ and length-modulated proportional to uᵢ. In the case of the previously discussed graph topology (FIG. 4), the set H is formed by the graph neighbors of A's current node location and A can only pick one such neighbor to relocate. In that case, A may for instance pick the hᵢ with the highest corresponding urgency uᵢ value, or normalize the entire set U into a probability distribution and draw hᵢ according to those probabilities.

The execution of the chosen movement step then changes A's location, which may entail a change in the agent's execution host.

Indicator Agent Interaction with Host Agent

As an Indicator Agent approaches a Host Agent, it may decide to interact with that Host Agent. That decision is taken probabilistically, where the probability to interact is the application-specific combination of the Host Agent's indicator urgency, signature detection probability, indicator constraint probability, and the time since the last interaction of the Indicator Agent with that Host Agent. If the Indicator Agent “A” decides to interact with a Host Agent “H”, it performs the following actions:
1) Reduce H's indicator urgency by multiplying it (decay) with a fixed factor in (0,1)
2) Across H and all its current neighbors who are within range (Host Agents similar to H due to the self-organizing clustering), apply A's constraint to all current and recent measurement values for that indicator in the Host State instances and estimate the probability that A's constraint is currently satisfied or not. Add that resulting probability value to H's indicator constraint probability value for A's signature and specific constraint.

Thus, as Indicator Agents find that their indicator has a high probability of being satisfied in the agents current space-time volume (the Host Agent it decided to interact with and others that are nearby and for all of those their recent history of indicator measurement values), then it significantly increases the indicator constraint probability of its signature at the Host Agent, which raises the detection probability of the signature as well as the re-assessment priority for the indicator, which, in turn attracts more Indicator agents to approach the Host Agent, and so forth. Hence, the present invention creates a positive feedback loop that recruits indicator agents to Host Agents that have a high probability of expressing one of the signatures of interest (FIG. 5). That positive feedback loop is limited by the finite number of Indicator Agents in the system and the time it takes for them to be recruited to visit the Host Agent.

### REFERENCES

H. Parunak and S. Brueckner, “Transitive Identity Mapping Using Force-Based Clustering,” in Agents and Data Mining Interaction, L. Cao, Y. Zeng, A. L. Symeonidis, V. Gorodetsky, J. P. Müller, and P. S. Yu, Eds. Springer Berlin Heidelberg, 2014, pp. 124-135.

1. A method of continuously monitoring a stream of values of various application-specific behavioral indicators of domain entities and detecting the occurrence of application-defined patterns (signatures) in the entity behavior in a distributed and decentralized computational or physical environment, comprising the steps of:
associating application-specific domain entities as producers of values of behavioral indicators with autonomous software Host Agents, each Host Agent being operative to perform independent processes, the processes including a Knowledge Management process and an Arrangement Process;
associating application-specific signatures to be detected with one or more constraints defined on the value of a specific indicator, where the probability of detection of the signature is a function of the probability of satisfaction of each indicator constraint in that signature;
associating each indicator constraint of each signature with one or more autonomous software Indicator Agents, each Indicator Agent being operative to perform independent processes, the processes including a Movement Decision process and a Host Agent Interaction Process; and
continuously and repeatedly executing the processes by the agents to maintain up-to-date probability estimates for the presence of specific signatures in the behavior of domain entities in accordance with the requirements of an application.

2. The method of claim 1, including the step of adding or removing Host Agents from the application as their corresponding application-specific domain entities are added to or removed from the application.

3. The method of claim 1, wherein the domain entities produce the behavioral indicator data and communicate the data stream to their respective Host Agent in the application.

4. The method of claim 1, wherein the domain entities are observed by a separate set of sensors that produce the behavioral indicator data and communicate the data stream to the respective Host Agent in the application.

5. The method of claim 1, including the step of assigning each Host Agent and each Indicator Agent a position in an application-specific topology.

6. The method of claim 1, wherein the Host and Indicator Agents have positions in the topology, the method including the step of enabling agents to manipulate their position.

7. The method of claim 5, wherein each Host Agent is able to estimate the distance between its position in the topology relative to another given position value.

8. The method of claim 1, wherein each Host Agent maintains a data structure, comprising, at a minimum, the following values:
(a) a numerical “priority” value for each behavioral indicator of the Host Agent,
(b) a numerical “urgency” value for each behavioral indicator of the Host Agent,
(c) a data structure for specific application-specific signatures, comprising of the following values:
(i) the unique identifier of the signature
(ii) the detection probability value of the signature
(iii) a satisfaction probability value for each indicator constraint of the signature

9. The method of claim 1, wherein a Host Agent is operative to perform the Knowledge Management process using the following steps:
(a) for each indicator, add the current priority value to the current urgency value and set the result as the new urgency value;
(b) for each indicator constraint in each signature data structure, multiply its current satisfaction probability with a numerical “decay” factor in the (0,1) interval and set the resulting value as the new satisfaction probability;
(c) for each indicator constraint in each signature data structure, remove the satisfaction probability from the data structure if its value is below an application-defined threshold;
(d) for each signature data structure, compute the product of all satisfaction probability values and set the resulting value as the signature's detection probability;
(e) for each signature data structure, remove the signature data structure if its detection probability value is below an application-defined threshold; and
(f) for each indicator, set the priority value to the sum of an application-defined base value and the satisfaction probability of that indicator in each signature data structure.

10. The method of claim 1, wherein a Host Agent “A” is operative to perform the Arrangement process using the following steps:
(a) enumerate all other Host Agents {h₁, . . . , hₙ} whose topology-defined distance to the position of A is below an application-defined threshold;
(b) for each such Host Agent compute an application-specific similarity measure sᵢ between current values of behavioral indicators in hᵢ and A; and
(c) utilizing the specific movement methods defined by the application-specific topology that defines A's position, reduce the topology-specific distance of A to hᵢ with a high sᵢ value while increasing the topology-specific distance of A to hⱼ with a low sᵢ value.

11. The method of claim 1, wherein an Indicator Agent “A” is operative to perform the Movement Decision process in the following steps:
(a) enumerate all Host Agents {h₁, . . . , hₙ} whose topology-defined distance to the position of A is below an application-defined threshold;
(b) for each such Host Agent consider the current urgency value uᵢ for the specific indicator assessed by A; and
(c) utilizing the specific movement methods defined by the application-specific topology that defines A's position, reduce the topology-specific distance of A to hᵢ with a high uᵢ.

12. The method of claim 1, wherein an Indicator Agent “A” is operative to perform the Host Agent Interaction process in the following steps:
(a) enumerate all Host Agents {h₁, . . . , hₙ} whose topology-defined distance to the position of A is below an application-defined threshold;
(b) for each such Host Agent hᵢ, compute a probability pᵢ to interact as the application-specific combination various values, including, but not limited to, hᵢ's urgency value for A's indicator, hᵢ's signature detection probability for A's signature, hᵢ's indicator constraint satisfaction probability for A's signature and indicator, and the time since the last interaction of A with hᵢ.
(c) using an application-specific selection function that determines whether and which Host Agent hᵢ to interact with, perform the following steps on hᵢ:
(i) taking the urgency value of hᵢ for A's indicator, multiply it with a numerical “decay” factor in the (0,1) interval and set the resulting value as the new urgency;
(ii) apply A's signature constraint to the behavioral indicator values of hᵢ and any additional Host Agents with a distance to hᵢ below an application-defined threshold and combine the resulting outcomes of the constraint application(s) into a new constraint satisfaction probability value S;
(iii) if A's signature has no corresponding data structure in hᵢ, create one; and
(iv) for A's signature's data structure in hᵢ, set A's indicator's satisfaction probability to S.

13. A method of claim 1, wherein Host Agents report their domain entity's identity and any signatures with a detection probability value above an application-defined threshold in accordance with the requirements of the application.

14. The method of claim 1, including signatures that represent abnormal behavior of a human or a machine.

15. The method of claim 1, including signatures that represent high or low utilization of a device or a machine.

16. The method of claim 1, wherein the behavioral indicators include measurements or activity reports.

17. The method of claim 1, wherein the application-specific domain entities include humans or machines.
